(19) United States
(12) Patent Application Publication
(10) Pub. No.: US 2014/0359327 A1
(43) Pub. Date: Dec. 4, 2014

(54) ELECTRONIC APPARATUS THAT PERFORMS COOLING DURING POWER-OFF, METHOD OF CONTROLLING THE SAME, AND STORAGE MEDIUM

(71) Applicant: CANON KABUSHIKI KAISHA, Tokyo (JP)

(72) Inventor: Hiroki Matsushima, Kawasaki-shi (JP)

(73) Assignee: CANON KABUSHIKI KAISHA, Tokyo (JP)

(21) Appl. No.: 14/288,725

(22) Filed: May 28, 2014

(30) Foreign Application Priority Data
Jun. 4, 2013 (JP) 2013-117792

(51) Int. Cl. G06F 1/32; G06F 1/26

(52) U.S. Cl. CPC G06F 1/3287; G06F 1/263
USPC 713/320

(57) ABSTRACT

A technique for controlling a power supply of an electronic apparatus, which makes it possible to positively cool the inside of the apparatus after turning off a main switch of the apparatus, thereby making it possible to reduce unnecessary power consumption. A battery is rechargeable by an AC power supply. A fan cools the apparatus by being driven by power supply from the AC power supply or the battery. A CPU of a system controller determines a power supply off time of the apparatus according to a state of the apparatus when the main switch is turned off. When the determined power supply off time is reached, the power supply controller switches the power supply from the AC power supply to the battery to continue driving the fan. Further, when the state of the apparatus satisfies predetermined conditions, the power supply controller stops driving of the fan.

### BACKGROUND OF THE INVENTION

1. Field of the Invention

The present invention relates to an electronic apparatus, a method of controlling the same, and a storage medium, and more particularly to a power supply control technique for controlling power supply to a cooling unit after switching off the power of an electronic apparatus that forms an image on a medium using thermal energy.

2. Description of the Related Art

Conventionally, in an electronic apparatus that performs image formation by a method of forming an image using thermal energy, heat is retained therein since it performs heating for fixing the image during image formation processing. This heat is a cause of various problems of toner in the apparatus, such as fusion, fixation, and degradation of apparatus body housing, component parts, and consumables. In view of this, a cooling unit is provided inside the electronic apparatus, such as an image forming apparatus, for cooling the apparatus during operation. Further, exhaust heat treatment is performed by driving an exhaust heat fan as the cooling unit only for a predetermined time period after termination of the image formation processing. As described above, a sudden rise in the temperature of the electronic apparatus, caused by the retained heat, is suppressed after termination of the image forming process, to thereby prevent the toner in the apparatus from being fused, fixed, and degrading the apparatus body housing, the component parts, and consumables.

Further, in such an electronic apparatus, to prevent the above-described adverse influences, cooling of the apparatus is performed, even after a main switch thereof is turned off by a user, by driving the exhaust heat fan as the cooling unit using AC power supply. As an example of such an electronic apparatus, one has been proposed which performs the above cooling only for a predetermined time period to sufficiently cool the apparatus by dissipating heat therefrom, and then completely cuts off power supply thereto. For example, Japanese Patent Laid-Open Publication No. 2001-5366 discloses an electronic apparatus that detects cutoff of AC power supply, and drives a cooling fan only for a predetermined time period. In Japanese Patent Laid-Open Publication No. 2001-5366, a technique has been disclosed which prevents a rise in the temperature of the electronic apparatus by arranging a detection unit that detects cutoff of the AC power supply to the apparatus to deliver a signal indicative of the detection of the cutoff, and a post-cutoff rotation unit that drives a cooling unit only for the predetermined time period even after cutoff of the AC power supply.

Further, Japanese Patent Laid-Open Publication No. 2005-340427, for example, proposes an electronic apparatus that detects cutoff of the AC power supply, switches the power source to a storage battery after the detection, and drives a cooling unit only for a predetermined time period. This publication discloses a technique of charging the storage battery by a device that converts thermal energy to electric energy during operation of the apparatus, detecting cutoff of the AC power supply using a detection unit, which delivers a signal indicative of the detection of the cutoff, and switching, in response to the signal, the source of power for driving the cooling unit to the storage battery to drive the cooling unit only for the predetermined time period even after the cutoff of the AC power supply, to thereby prevent a rise in the temperature of the apparatus.

Although in Japanese Patent Laid-Open Publication No. 2001-5366 and Japanese Patent Laid-Open Publication No. 2005-340427, descriptions are given of the respective cooling units that operate in the case where the AC power supply is cut off during cooling of the electronic apparatuses, no description is given of a method of cooling the electronic apparatus in a case where the apparatus is intentionally cooled by the cooling unit only for a predetermined time period after the user turns off the main switch. That is, in this case, the cooling unit is driven by the AC power supply for the predetermined time period even after the user turns off the main switch, and hence electric power is supplied to the apparatus only for driving the cooling unit, which brings about a problem of unnecessary power consumption.

Further, since the apparatus remains in operation after turning off the main switch, the user is caused to wait for the power supply to be completely turned off.

### SUMMARY OF THE INVENTION

The present invention provides a technique for controlling power supply of an electronic apparatus, which makes it possible to positively cool the inside of the electronic apparatus after turning off a main switch of the electronic apparatus, thereby making it possible to reduce unnecessary power consumption.

In a first aspect of the present invention, there is provided an electronic apparatus that includes a switch operable by a user to be turned on or off, and operates by being supplied with electric power from a first power supply outside thereof by having the switch turned on, comprising a second power supply configured to be rechargeable by the first power supply, a cooling unit configured to cool the electronic apparatus by being driven by power supply from the first power supply or the second power supply, and a power supply control unit configured to determine a power supply off time of the electronic apparatus according to a state of the electronic apparatus when the switch is turned off, wherein the power supply control unit causes, when the determined power supply off time is reached, the cooling unit to be driven by switching the first power supply to the second power supply, and causes, when the state of the electronic apparatus satisfies predetermined conditions, the cooling unit to be stopped from being driven.

In a second aspect of the present invention, there is provided a method of controlling an electronic apparatus that includes a switch operable by a user to be turned on or off, and operates by being supplied with electric power from a first power supply outside thereof by having the switch turned on, comprising cooling the electronic apparatus by causing a cooling unit to be driven by power supply from the first power supply or a second power supply rechargeable by the first power supply, determining a power supply off time of the electronic apparatus according to a state of the electronic apparatus when the switch is turned off, and causing, when the determined power supply off time is reached, the cooling unit to be driven by switching the first power supply to the second power supply, and causing, when the state of the electronic apparatus satisfies predetermined conditions, the cooling unit to be stopped from being driven.

In a third aspect of the present invention, there is provided a non-transitory computer-readable storage medium storing a computer-executable program for executing a method of controlling an electronic apparatus that includes a switch operable by a user to be turned on or off, and operates by being supplied with electric power from a first power supply outside thereof by having the switch turned on, wherein the method comprises cooling the electronic apparatus by causing a cooling unit to be driven by power supply from the first power supply or a second power supply rechargeable by the first power supply, determining a power supply off time of the electronic apparatus according to a state of the electronic apparatus when the switch is turned off, and causing, when the determined power supply off time is reached, the cooling unit to be driven by switching the first power supply to the second power supply, and causing, when the state of the electronic apparatus satisfies predetermined conditions, the cooling unit to be stopped from being driven.

According to the present invention, the electronic apparatus causes a cooling device to operate only for a predetermined time period after turning off the main switch of the electronic apparatus. This makes it possible to positively cool the inside of the electronic apparatus after turning off the main switch of the electronic apparatus, thereby making it possible to reduce unnecessary power consumption.

Further features of the present invention will become apparent from the following description of exemplary embodiments (with reference to the attached drawings).

### BRIEF DESCRIPTION OF THE DRAWINGS

FIG. 1 is a schematic block diagram of an image forming apparatus as an electronic apparatus according to a first embodiment of the present invention.

FIG. 2 is a schematic block diagram of a system controller appearing in FIG. 1.

FIG. 3 is a schematic block diagram of a power supply controller appearing in FIG. 1.

FIG. 4 is a flowchart of a power supply control process performed by the image forming apparatus.

FIG. 5 is a diagram of an example of a power-off timing table which indicates timing of turning off power from an AC power supply of the image forming apparatus.

FIG. 6 is a flowchart of a process for updating the power-off timing table which is shown in FIG. 5 and is referred to in a step in the power supply control process shown in FIG. 4.

FIG. 7 is a schematic block diagram of an image forming apparatus as an electronic apparatus according to a second embodiment of the present invention.

### DESCRIPTION OF THE EMBODIMENTS

The present invention will now be described in detail below with reference to the accompanying drawings showing embodiments thereof.

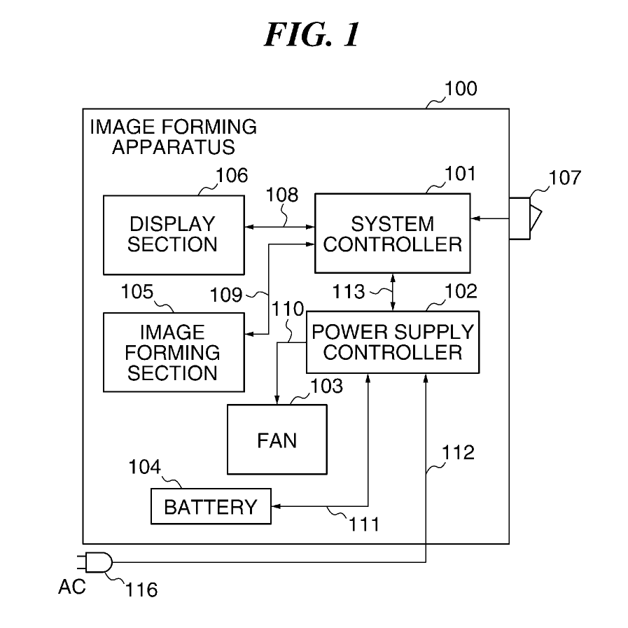

FIG. 1 is a schematic block diagram of an image forming apparatus as an electronic apparatus according to a first embodiment of the present invention.

The image forming apparatus 100 comprises a system controller 101, a power supply control section 102, a fan 103, a battery 104, an image forming section 105, a display section 106, and a main switch 107.

The system controller 101 is connected to the power supply control section 102, the image forming section 105, the display section 106, and the main switch 107, and controls the overall operation of the image forming apparatus 100. A detailed description thereof will be given hereinafter.

The power supply control section 102 is connected to the system controller 101, the fan 103, the battery 104, and an AC power supply 116, and controls supply of electric power to the sections of the image forming apparatus 100. A detailed description thereof will be given hereinafter.

The display section 106 comprises a display device controller and a display device, neither of which is shown. The display device includes e.g. a liquid crystal panel, and displays the status of the image forming apparatus 100 etc. Further, the display device includes an instruction input unit (not shown) for inputting instructions from a user, and also plays a role of receiving setting information of e.g. the number of printing sheets and a printing method. The display device controller has a CPU (not shown) of its own and performs control of data to be displayed on the display device and recognition of instructions from the user received by the display device. Further, the display device controller is connected to the system controller 101 by a display section control signal line 108, and also plays a role of receiving display data transmitted from the system controller 101 and a role of transmitting instructions from the user to the system controller 101. The CPU of the display device controller is capable of operating independently of the system controller 101.

The image forming section 105 comprises a print controller and a printer, neither of which is shown. The printer includes a printer section, not shown, for printing print data on sheets, and a sheet conveying section, not shown, for conveying sheets. Further, for maintenance thereof, the printer is also provided with a cooling mechanism and a cleaning mechanism, neither of which is shown. The printer section includes e.g. a fixing device for thermally fixing an image on a paper medium or the like by thermal energy. Therefore, the printer section can be regarded as a heat generation section of the image forming apparatus 100.

The print controller includes a CPU (not shown) of its own, and performs control of the printer, such as control of print data to be printed by the printer, sheet feed control, and control of cleaning and cooling of the printer. Further, the print controller is connected to the system controller 101 by an image forming section control signal line 109, and also plays a role of receiving print data transmitted from the system controller 101 and a role of transmitting the status of the printer to the system controller 101. The CPU of the print controller is capable of operating independently of the system controller 101.

The main switch 107 is a switch with which the user can turn on or off the power of the image forming apparatus 100. The main switch 107 is connected not to the power supply control section 102 but to the system controller 101, and hence even when the main switch 107 is turned off, the power of the image forming apparatus 100 is not instantly turned off.

The power supply control section 102 is connected to the fan 103 by a fan control signal line 110. Further, the power supply control section 102 is connected to the battery 104 by a battery control signal line 111. Further, the power supply control section 102 is connected to the AC power supply 116, which is a commercial power supply, by a main power supply line 112. Furthermore, the power supply control section 102 is connected to the system controller 101 by a power supply section control signal line 113.

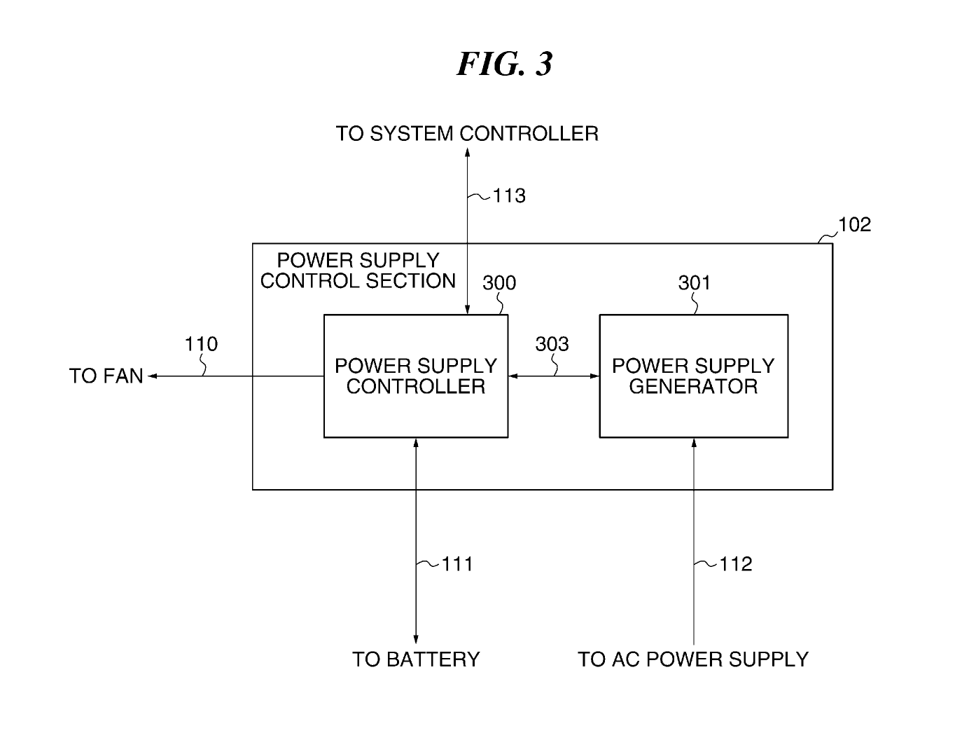

The battery 104 is a rechargeable battery which can be charged by DC power which a power supply generator 301 (see FIG. 3) generates by converting AC power from the AC power supply 116.

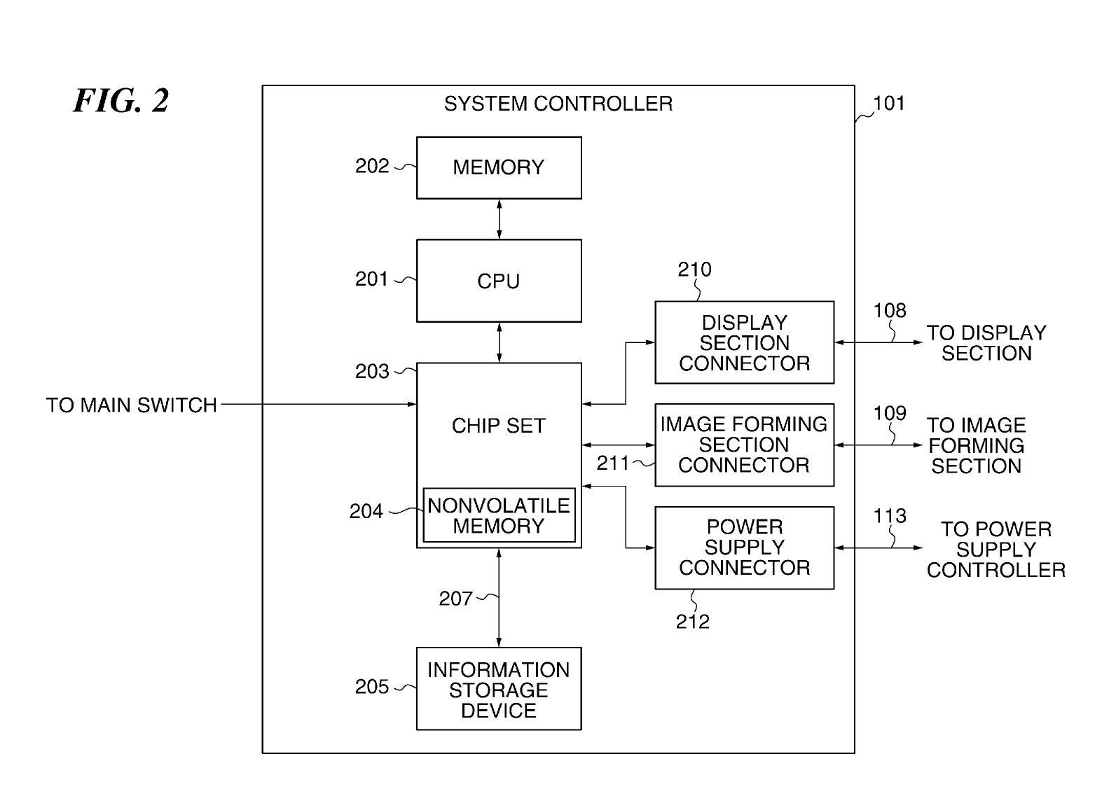

FIG. 2 is a schematic block diagram of the system controller 101 appearing in FIG. 1.

The system controller 101 includes a CPU 201, a memory 202, a chip set 203, and an information storage device 205. The information storage device 205 is a nonvolatile storage device, and stores data required for starting the system controller 101. Further, the information storage device 205 is capable of storing desired user data.

The CPU 201 not only controls the overall operation of the image forming apparatus 100 using an operating system (OS), but also generates print data to be printed by the image forming section 105 and display data to be displayed by the display section 106.

The chip set 203 is an input/output (I/O) controller for connecting between the system control 101 and an external interface. The display section 106, the image forming section 105, and the power supply control section 102 are connected to the chip set 203 via a display section connector 210, an image forming section connector 211, and a power supply connector 212, respectively, and are controlled by the CPU 201. Further, the information storage device 205 is connected to the chip set 203 via a dedicated bus 207, such as a serial ATA, and reading and writing data from and into the information storage device 205 are controlled by the CPU 201. Further, the chip set 203 includes a general-purpose input/output (I/O) pin. The main switch 107 is connected to the input/output pin such that the on/off of the main switch 107 is transmitted to the CPU 201. Furthermore, the chip set 203 includes a nonvolatile memory 204, and information indispensable to the start of the chip set 203 is stored in the nonvolatile memory 204.

The memory 202 is directly connected to the CPU 201, and is controlled by a memory controller, not shown, provided within the CPU 201. The memory 202 is used not only as an area into which various kinds of applications executed by the CPU 201 are loaded but also for generating display data to be transmitted to the display section 106 and print data to be transmitted to the image forming section 105.

FIG. 3 is a schematic block diagram of the power supply control section 102 appearing in FIG. 1.

The power supply control section 102 includes a power supply controller 300 and the power supply generator 301. The power supply generator 301 is connected to the AC power supply 116 via the main power supply line 112, and includes a transformer (not shown) for transforming AC power obtained via the main power supply line 112, and an AC-to-DC converter (not shown) for converting the transformed AC power to DC power.

The power supply controller 300 is connected to the power supply generator 301 via a power supply controller control signal line 303, and performs control of electric power generated by the power supply generator 301, and control of supply of electric power to sections of the image forming apparatus 100, such as the system controller 101 and the image forming section 105.

Further, the power supply controller 300 is connected to the battery 104 via the battery control signal line 111, and performs control of charging and discharging of the battery 104 and measurement of a charge amount of the battery 104. Further, the power supply controller 300 is connected to the fan 103, which is a cooling unit of the image forming apparatus 100, by the fan control signal line 110, and drivingly controls the fan 103. Further, the power supply controller 300 is connected to the system controller 101 via the power supply section control signal line 113, and executes or inhibits power supply to sections of the image forming apparatus 100 according to instructions from the system controller 101.

Next, a description will be given of a power supply control process executed by the image forming apparatus 100.

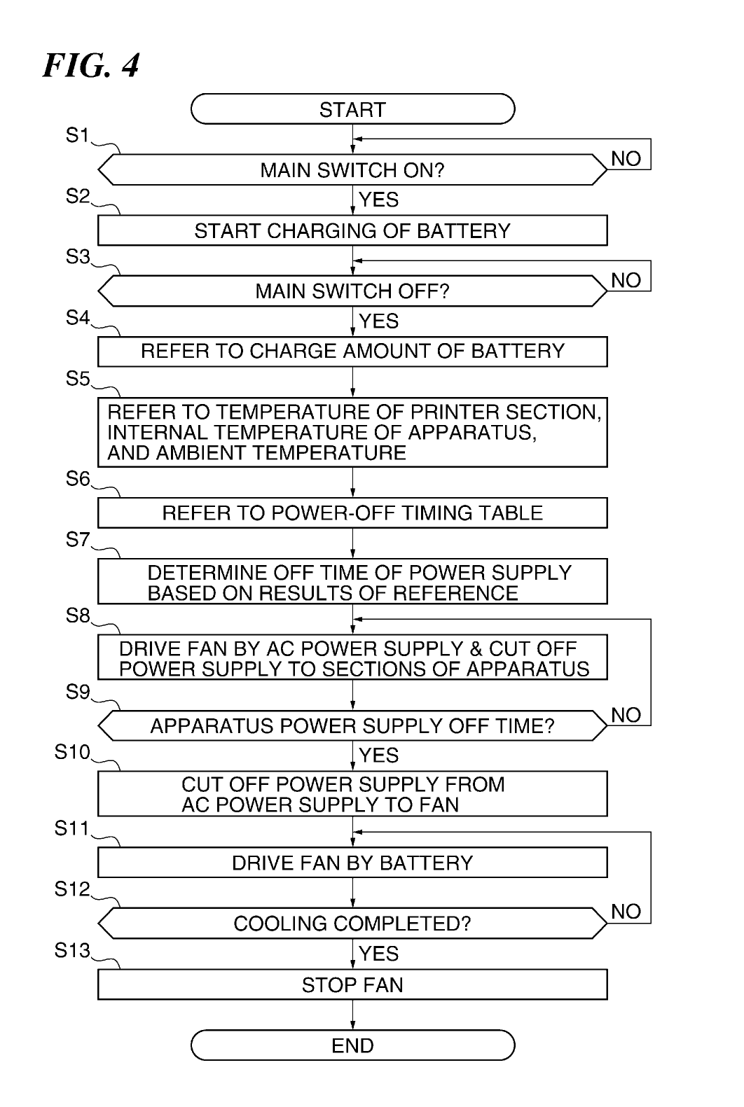

FIG. 4 is a flowchart of the power supply control process executed by the image forming apparatus 100.

First, upon receipt of a signal indicating an on operation of the main switch 107 (YES to a step S1), the CPU 201 transmits a startup control signal to the power supply control section 102 via the chip set 203, to start up the image forming apparatus 100.

Upon receipt of the startup control signal, the power supply control section 102 generates DC power from AC power obtained from the AC power supply 116 via the main power supply line 112, using the power supply generator 301, and executes power supply to the sections of the image forming apparatus 100. At this time, the power supply controller 300 simultaneously starts charging of the battery 104 via the battery control signal line 11 (step S2). After being started up, the image forming apparatus 100 provides various functions to the user.

When the CPU 201 receives a signal indicating an off operation from the main switch 107 (YES to a step S3), it refers to the charge amount of the battery 104 measured by the power supply controller 300 of the power supply control section 102 (step S4).

Next, the CPU 201 refers to the temperature of the printer section of the image forming section 105, the ambient temperature of the image forming apparatus 100, and the internal temperature of the image forming apparatus 100, detected by respective temperature sensors (not shown) mounted on the image forming apparatus 100 (step S5). The ambient temperature of the image forming apparatus 100 is substantially the same as the temperature of the periphery of the image forming apparatus 100, and the internal temperature of the image forming apparatus 100 is the temperature of the other internal part of the image forming apparatus 100 than the printer section.

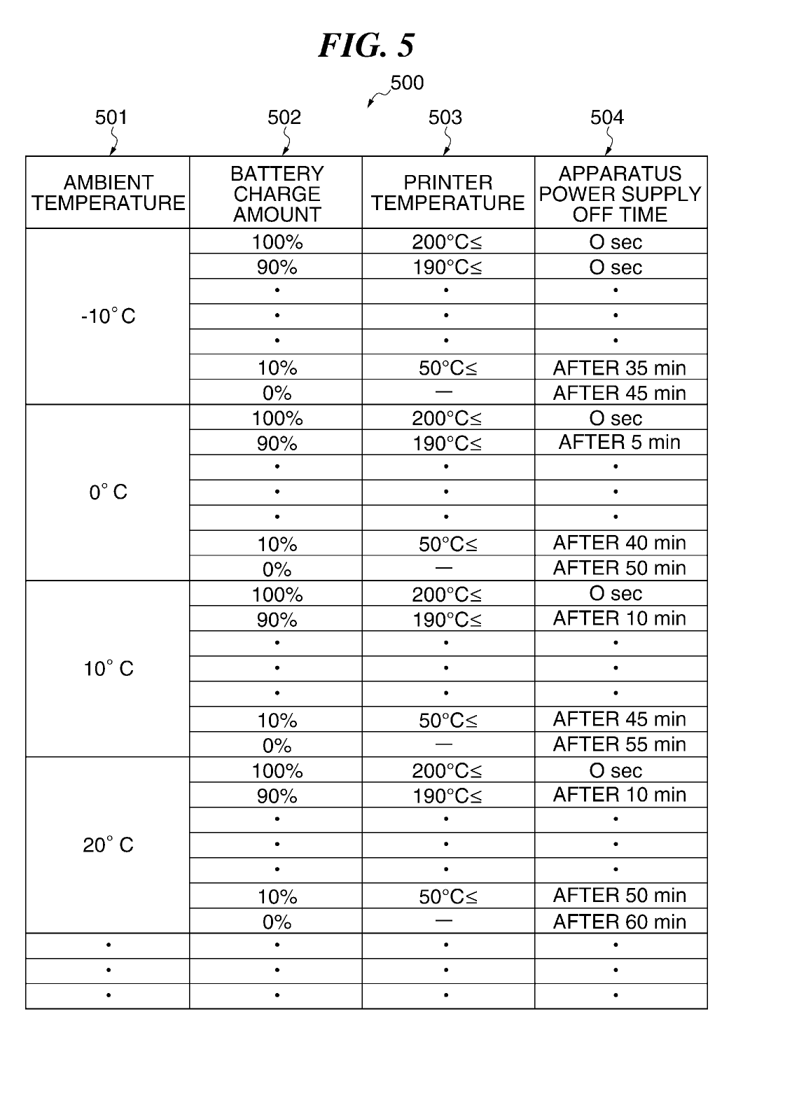

Then, the CPU 201 refers to a power-off timing table stored in the information storage device 205 (step S6). An example of the power-off timing table is shown in FIG. 5. Note that the power-off timing table, denoted by reference numeral 500 in FIG. 5, may be stored in a nonvolatile memory, such as an HDD (not shown).

In FIG. 5, ambient temperature 501 indicates the ambient temperature of the image forming apparatus 100, and battery charge amount 502 indicates the charge amount of the battery 104. Printer temperature 503 indicates the temperature of the printer section (heat generation section) in the image forming section 105, which can be cooled by the fan 103 according to the charge amount of the battery 104. Apparatus power supply off time 504 indicates timing at which the power supply is switched from power supply from the AC power supply 116 to power supply from the battery 104. Although the internal temperature of the image forming apparatus 100 is not indicated as an item in the illustrated table, the table may be configured such that it enables the apparatus power supply off time to be determined by taking the internal temperature into account. Further, the table can be configured such that it contains all parameters, including the status of the apparatus and an input voltage, which can be acquired from the image forming apparatus 100, as the parameters to be referred to. Alternatively, the table may be configured such that it contains only the parameter of the charge amount of the battery and the off time of the apparatus power supply is determined based thereon.

Referring again to FIG. 4, in a step S7, the CPU 201 determines the off time of the power supply to the apparatus based on results of the reference in the step S6, and transmits the determined off time together with a shutdown signal to the power supply control section 102 via the power supply section control signal line 113.

The power supply controller 300 of the power supply control section 102 receives the shutdown signal and the apparatus power supply off time transmitted from the CPU 201. Then, the power supply controller 300 supplies electric power of the AC power supply 116 generated by the power supply generator 301 to the fan 103 via the fan control signal line 110, and drives the fan 103. At the same time, the power supply control section 102 cuts off power supply from the AC power supply 116 to the sections (such as the image forming section) of the image forming apparatus 100, and turns off the power (step S8). Although in the illustrated example, the fan 103 starts to be driven by electric power from the AC power supply 116 when the shutdown signal is received by the power supply control section 102, it may be started to be driven when the main switch 107 is turned on in the step S1.

The power supply controller 300 causes a timer, not shown, to operate, to count up to the apparatus power supply off time received in the step S8, and determines whether or not the apparatus power supply off time has arrived (step S9). If it is determined that the apparatus power supply off time has arrived, the power supply controller 300 cuts off power supply from the AC power supply 116 to the fan 103 (step S10). Note that although the power supply from the AC power supply 116 to the sections (such as the image forming section) of the image forming apparatus 100 is cut off in the step S8, the power supply from the AC power supply 116 may be cut off in the step S1.

Next, in a step S11, the power supply controller 300 switches the power supply to the fan 103 from power supply from the AC power supply 116 to power supply from the battery 104, and drives the fan 103.

Then, the power supply controller 300 determines whether or not the temperatures of the sections of the image forming apparatus 100, detected by the temperature sensors, have become equal to or lower than a predetermined temperature, to thereby determine whether or not the sections of the image forming apparatus 100 have been sufficiently cooled (step S12). If it is determined that the sections of the image forming apparatus 100 have been sufficiently cooled, the power supply controller 300 cuts off the power supply to the fan 103 to thereby completely stop driving of the fan 103 (step S13).

In the step S12, the determination as to whether or not the sections of the image forming apparatus 100 have been sufficiently cooled is performed by determining whether or not the temperatures of the sections of the image forming apparatus 100 have become equal to or lower than the predetermined temperature. Note that a time period required to elapse before the power supply from the battery 104 is cut off after cutting off the power supply from the AC power supply 116 may be set in the power-off timing table 500 shown in FIG. 5. Further, the power supply controller 300 may be configured to terminate monitoring when the fan 103 starts to be driven by electric power supplied from the battery 104 in the step S11, and the fan 103 may continue to be driven until the charge amount of the battery 104 is reduced to zero to terminate electric discharge therefrom.

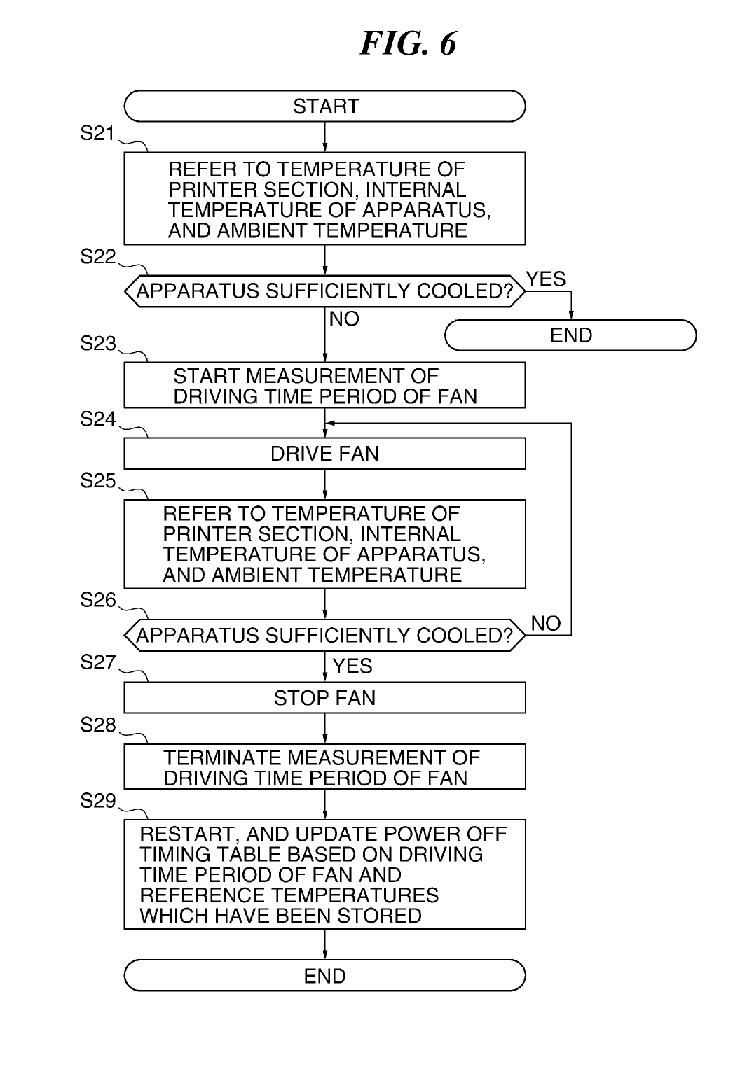

FIG. 6 is a flowchart of a process for updating the power-off timing table which is shown in FIG. 5 and is referred to in the step 6 of the power supply control process shown in FIG. 4. This process is executed after the fan is stopped in the step S13 of the power supply control process shown in FIG. 4.

First, the power supply controller 300 refers to the temperatures of the sections of the image forming apparatus 100, measured by the temperature sensors (not shown) (step S21). The power supply controller 300 determines whether or not the temperatures of the sections of the image forming apparatus 100 are equal to or lower than a predetermined temperature, to thereby determine whether or not the sections of the image forming apparatus 100 have been sufficiently cooled (step S22). If it is determined that the sections of the image forming apparatus 100 have been sufficiently cooled (YES to the step S22), the power supply controller 300 terminates the present process. If it is determined that the temperatures of the sections have not become equal to or lower than the predetermined temperature (NO to the step S22), the power supply controller 300 starts measurement of a driving time period of the fan 103 using a timer, not shown (step S23). At the same time, the power supply controller 300 starts to drive the fan 103 (step S24). Here, if the battery 104 can be discharged, electric power is supplied from the battery 104, whereas if electric power cannot be supplied from the battery 104, it is supplied from the AC power supply 116, to thereby drive the fan 103.

Then, the power supply controller 300 refers again to the temperatures of the sections of the image forming apparatus 100, measured by the temperature sensors (step S25). The power supply controller 300 determines whether or not the temperatures of the sections have become equal to or lower than the predetermined temperature, to thereby determine whether or not the sections of the image forming apparatus 100 have been sufficiently cooled (step S26). If it is determined that the sections of the image forming apparatus 100 have been sufficiently cooled, the power supply controller 300 cuts off the power supply to the fan 103, and stops driving of the fan 103 (step S27). At the same time, the power supply controller 300 terminates the measurement of the driving time period of the fan 103 using the timer, not shown (step S28).

Next, the power supply controller 300 stores data of the measured driving time period of the fan 103 and the temperatures referred to, in a rewritable nonvolatile memory (not shown), cuts off all the power supplies, and then starts up the image forming apparatus again. Then, after the image forming apparatus 100 is started up again, the data stored in the rewritable nonvolatile memory is transmitted to the system controller 101, and the CPU 201 updates the power-off timing table 500 stored in the information storage device 205 based on the data (step S29).

Although in the present embodiment, the description is given of the time of the shutdown, by way of example, it can be applied to the respective times of a power saving operation and a sleep operation in low-power-consumption operation modes provided in the electronic apparatus. Further, although the cooling unit uses the fan 103, a device, such as a peltier device, may be used in place of the fan 103, insofar as the device is capable of cooling the inside of the apparatus.

According to the present embodiment, when the main switch 107 is turned off, the power supply off time is determined according to the status of the image forming apparatus 100. Then, when the elapsed time has reached the determined power supply off time, the fan 103 as the cooling unit starts to be driven by switching the power supply from power supply from the AC power supply 116 to power supply from the battery 104. When the status of the image forming apparatus 100 satisfies predetermined conditions, the driving of the fan 103 is stopped. This eliminates the need to supply electric power to the sections of the image forming apparatus 100 at the time of shutdown only in order to cool the inside of the apparatus, thereby making it possible to reduce unnecessary power consumption.

Although in the above-described embodiment, the description has been given of the configuration for charging the battery 104 by power supply from the AC power supply 116, the battery 104 may be charged by another power supply unit.

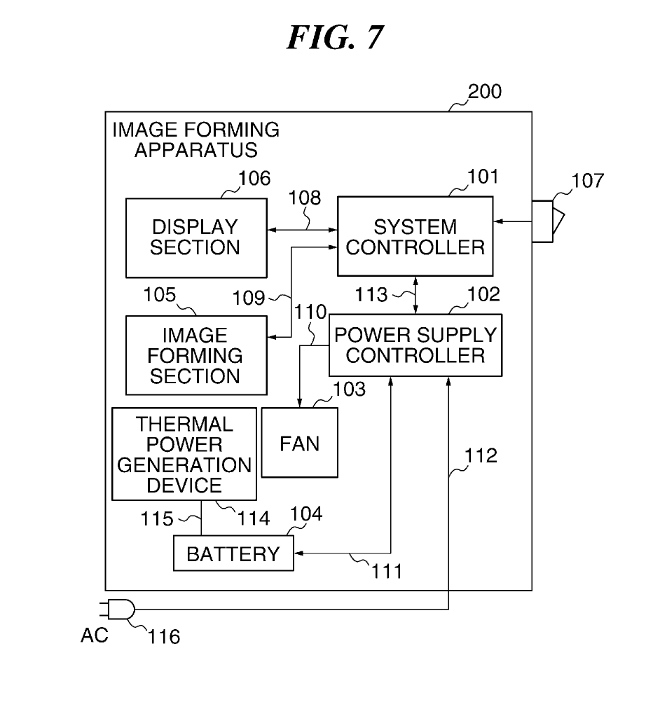

FIG. 7 is a schematic block diagram of an image forming apparatus as an electronic apparatus according to a second embodiment of the present invention.

The image forming apparatus 200 comprises the system controller 101, the power supply control section 102, the fan 103, the battery 104, the image forming section 105, the display section 106, the main switch 107, and a thermal power generation device 114. The image forming apparatus 200 is distinguished from the image forming apparatus 100 shown in FIG. 1 only in that the thermal power generation device 114 and a thermal power generation supply line 115 are added. The other components than 114 and 115 are the same as described with reference to FIG. 1.

Referring to FIG. 7, the thermal power generation device 114 is connected to the battery 104 via the thermal power generation supply line 115, and supplies electric power to the battery 104. The thermal power generation device 114 converts thermal energy to electric energy (energy conversion unit), and generates electric power by a temperature difference between one surface and the other surface thereof. Therefore, the thermal power generation device 114 is configured such that one surface forms a high-temperature section and the other surface forms a low-temperature section. As described above, the thermal power generation device 114 absorbs extra heat generated by the image forming apparatus 200, and converts the same to electric energy.

Next, a power supply control process executed by the image forming apparatus 200 will be described with reference to FIG. 4. The following description is given of only different points from the first embodiment.

First, upon receipt of a signal indicating an on operation from the main switch 107 (YES to the step S1), the system controller 101 of the image forming apparatus 200 transmits a startup control signal to the power supply control section 102 via the chip set 203, and starts up the image forming apparatus 200.

Upon receipt of the startup control signal, the power supply control section 102 generates DC power from AC electric power obtained from the AC power supply 116 via the main power supply line 112, using the power supply generator 301, and executes power supply to the sections of the image forming apparatus 200. At this time, since the image forming apparatus 200 has started to be started up, heat is generated from the image forming section 105 and the system controller 101. Accordingly, this heat is converted to electric energy by the thermal power generation device 114, and the electric energy is supplied to the battery 104, to thereby start charging of the battery 104 (step S2). The steps subsequent thereto are the same as those described as to the first embodiment with reference to FIG. 4.

Although in the present embodiment, electric power is supplied to the battery 104 using the thermal power generation device 114 as an electric power source, power supply to the battery 104 may be performed using other power generation devices, such as a solar cell device, a vibration power generation device, and a radio wave power generation device.

According to the present embodiment, charging of the battery 104 is performed by supplying electric power to the battery 104 by the thermal power generation device 114. As a consequence, since electric power generated by the thermal power generation device 114 as a power supply source of the battery is used, it is possible to further reduce power consumption.

Although in the above-described embodiment, the image forming apparatus has been described as an electronic apparatus, by way of example, this is not limitative, but the present invention can also be applied to other electronic apparatuses, including a projector, a server PC, and a personal computer, each of which has a high-temperature heat generating source. Further, another object of the present invention is to provide an apparatus capable of positively cooling inside thereof after switching off the main switch.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Patent Application No. 2013-117792 filed Jun. 4, 2013 which is hereby incorporated by reference herein in its entirety.

What is claimed is:

1. An electronic apparatus that includes a switch operable by a user to be turned on or off, and operates by being supplied with electric power from a first power supply outside thereof by having the switch turned on, comprising:
a second power supply configured to be rechargeable by the first power supply;
a cooling unit configured to cool the electronic apparatus by being driven by power supply from the first power supply or said second power supply; and
a power supply control unit configured to determine a power supply off time of the electronic apparatus according to a state of the electronic apparatus when the switch is turned off,
wherein said power supply control unit causes, when the determined power supply off time is reached, said cooling unit to be driven by switching the first power supply to said second power supply, and causes, when the state of the electronic apparatus satisfies predetermined conditions, said cooling unit to be stopped from being driven.

2. The electronic apparatus according to claim 1, further comprising a detection unit configured to detect respective temperatures of sections of the electronic apparatus, and
wherein said power supply control unit determines the power supply off time of the electronic apparatus according to the respective temperatures of the sections detected by said detection unit.

3. The electronic apparatus according to claim 2, wherein when the respective temperatures of the sections detected by said detection unit have become equal to or lower than a predetermined temperature, said power supply control unit causes said cooling unit to be stopped from being driven.

4. The electronic apparatus according to claim 1, further comprising a first measurement unit configured to measure a driving time period over which said cooling unit has been driven, and
wherein when the driving time period measured by said first measurement unit has reached the power supply off time, said power supply control unit causes said cooling unit to be driven by switching the first power supply to said second power supply.

5. The electronic apparatus according to claim 1, further comprising a second measurement unit configured to measure a charge amount of said second power supply, and
wherein said power supply control unit determines the power supply off time of the electronic apparatus according to the charge amount of said second power supply measured by said second measurement unit.

6. The electronic apparatus according to claim 1, wherein after said cooling unit is stopped from being driven, when it is determined that the electronic apparatus has not been sufficiently cooled by said cooling unit, said power supply control unit rewrites the predetermined conditions.

7. The electronic apparatus according to claim 1, further comprising an energy conversion unit configured to convert thermal energy to electric energy, and
wherein the charging of said second power supply is performed using the electric energy obtained by said energy conversion unit.

8. The electronic apparatus according to claim 1, wherein said second power supply starts to be charged by turning-on of the switch.

9. A method of controlling an electronic apparatus that includes a switch operable by a user to be turned on or off, and operates by being supplied with electric power from a first power supply outside thereof by having the switch turned on, comprising:
cooling the electronic apparatus by causing a cooling unit to be driven by power supply from the first power supply or a second power supply rechargeable by the first power supply;
determining a power supply off time of the electronic apparatus according to a state of the electronic apparatus when the switch is turned off; and
causing, when the determined power supply off time is reached, the cooling unit to be driven by switching the first power supply to the second power supply, and causing, when the state of the electronic apparatus satisfies predetermined conditions, the cooling unit to be stopped from being driven.

10. A non-transitory computer-readable storage medium storing a computer-executable program for executing a method of controlling an electronic apparatus that includes a switch operable by a user to be turned on or off, and operates by being supplied with electric power from a first power supply outside thereof by having the switch turned on,
wherein the method comprises:
cooling the electronic apparatus by causing a cooling unit to be driven by power supply from the first power supply or a second power supply rechargeable by the first power supply;
determining a power supply off time of the electronic apparatus according to a state of the electronic apparatus when the switch is turned off; and
causing, when the determined power supply off time is reached, the cooling unit to be driven by switching the first power supply to the second power supply, and causing, when the state of the electronic apparatus satisfies predetermined conditions, the cooling unit to be stopped from being driven.
